(19) United States
(12) Patent Application Publication
(10) Pub. No.: US 2014/0222750 A1
(43) Pub. Date: Aug. 7, 2014

(54) TECHNIQUE FOR CONFIRMING SETTING INFORMATION

(71) Applicant: FUJITSU LIMITED, Kawasaki-shi (JP)

(72) Inventors: Tetsuya UCHIUMI, Kawasaki (JP); Yasuhide Matsumoto, Kawasaki (JP); Shinji Kikuchi, Yokohama (JP); Shinya Kitajima, Inagi (JP)

(73) Assignee: FUJITSU LIMITED, Kawasaki-shi (JP)

(21) Appl. No.: 14/246,717

(22) Filed: Apr. 7, 2014

Related U.S. Application Data
(63) Continuation of application No. PCT/JP2012/051794, filed on Jan. 27, 2012.

(51) Int. Cl. G06N 5/04

(52) U.S. Cl. CPC G06N 5/04
USPC 706/52

(57) ABSTRACT

A disclosed method includes: generating a first rule for each parameter from first data including a parameter value of each parameter; generating a second rule for each parameter from second data that is data after at least one parameter value included in the first data was changed; generating, for each group including one or plural parameters, a pair of the first rule and the second rule, which include a parameter of the group; calculating, for each pair, a first consistency ratio by applying the first rule included in the pair to the second data and a second consistency ratio by applying the second rile included in the pair to the first data; with respect to a first pair whose second consistency ratio exceeds the first consistency ratio, presenting a parameter value of a parameter, which contradicts the second rule included in the pair, in the second data to a user.

### CROSS-REFERENCE TO RELATED APPLICATIONS

This application is a continuing application, filed under 35 U.S.C. section 111(a), of International Application PCT/JP2012/051794, filed on Jan. 27, 2012, the entire contents of which are incorporated herein by reference.

### FIELD

This technique relates to a technique for confirming setting information for apparatuses.

### BACKGROUND

In a large-scale system such as cloud systems, there are a lot of cases where setting information such as host name and gateway is registered and/or changed. Therefore, a lot of troubles such as system failures, which are caused by setting errors, may occur, however, it is limited to reduce the setting errors by human confirmation or the like.

On the other hand, there is a method to extract a rule, which is applicable to almost all setting parameters, and mechanically detect setting parameters as error candidates, which violate the extracted rule. For example, data as illustrated in FIG. 1A is assumed. In other words, setting values for parameters 1 and 2 are set to each of setting targets 1 to 7. In such a case, a first rule that the value of the parameter 2 is “B” when the value of the parameter 1 is “A”, and a second rule that the value of the parameter 2 is “D” when the value of the parameter 1 is “C” are extracted. When these first and second rules are applied to the data illustrated in FIG. 1A, as illustrated in FIG. 1B, as for the setting target “5”, the value of the parameter 1 is “A”, however, the value of the parameter 2 is “E”. Therefore, this violates the first rule. Therefore, because the setting value of the parameter 2 for the setting target “5” may be an error, it may be presented as the error candidate to the user.

However, when the rule is changed by an incorrect setting change, it is impossible to point out the error of the setting change, and it is impossible to detect the setting mistake from the rule after change. Although other various related techniques exist, there is no technique to solve such a problem.

Patent Document 1: Japanese Laid-open Patent Publication No. 2007-87232

Patent Document 2: Japanese Laid-open Patent Publication No. 2007-304759

Patent Document 3: Japanese Laid-open Patent Publication No. 2006-58938

Patent Document 4: Japanese Laid-open Patent Publication No. 2004-282662

Patent Document 5: Japanese Laid-open Patent Publication No. 2009-199321

Patent Document 6: Japanese Laid-open Patent Publication No. 2009-25167

Non-Patent Document 1: Filho, J. C. R., Affonso, C. M., Oliveira, R. C. L., “Pricing analysis in the Brazilian energy market: A decision tree approach”, PowerTech, 2009 IEEE Bucharest

In other words, there is no technique for appropriately extracting mistakes of setting changes.

### SUMMARY

An information processing method relating to this technique includes (A) first generating a first rule for each of plural parameters from first data including a parameter value of each of the plural parameters for each of plural setting targets; (B) second generating a second rule for each of the plural parameters from second data that is data after at least one parameter value included in the first data was changed; (C) third generating, for each group including one or plural parameters among the plural parameters, a pair of the first rule and the second rule, which include a parameter of the group; (D) calculating, for each pair of plural generated pairs, a first consistency ratio by applying the first rule included in the pair to the second data and a second consistency ratio by applying the second rule included in the pair to the first data; (E) with respect to a first pair whose second consistency ratio exceeds the first consistency ratio, first presenting a parameter value of a parameter, which contradicts the second rule included in the pair, in the second data to a user; and (F) with respect to a second pair whose first consistency ratio exceeds the second consistency ratio, second presenting a changed parameter value among parameter values of parameters relating to the pair to the user.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1A is a diagram depicting a configuration example of a system;

FIG. 1B is a diagram depicting a configuration example of a system;

FIG. 2 is an outline diagram of a system;

FIG. 3 is a diagram depicting an example of present setting data (setting data before change);

FIG. 4 is a diagram depicting a processing flow relating to this embodiment;

FIG. 5 is a diagram depicting an example of setting data after change;

FIG. 6 is a diagram to explain a first rule;

FIG. 7 is a diagram to explain a second rule;

FIG. 8 is a diagram depicting an example of a comparison rule pair;

FIG. 9 is a diagram depicting an example of a consistency ratio;

FIG. 10 is a diagram depicting a processing flow relating to this embodiment;

FIG. 11 is a diagram depicting an example of output data generated by an output processing unit;

FIG. 12 is a diagram depicting another example of the comparison rule pair; and

FIG. 13 is a functional block diagram of a computer.

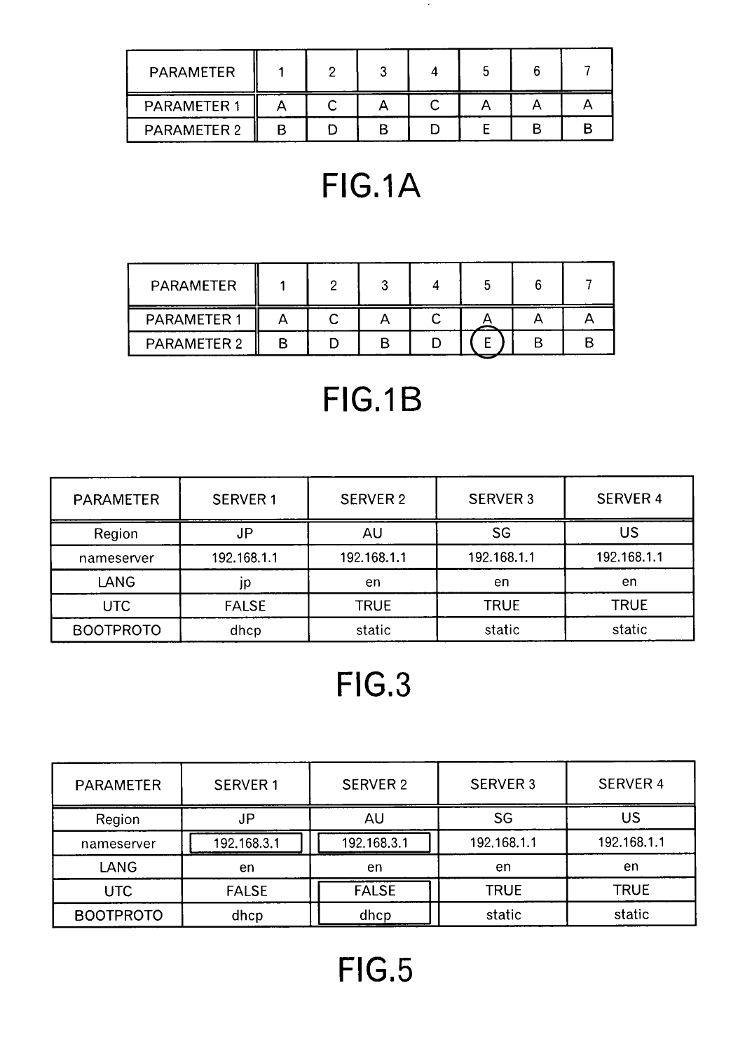

### DESCRIPTION OF EMBODIMENTS

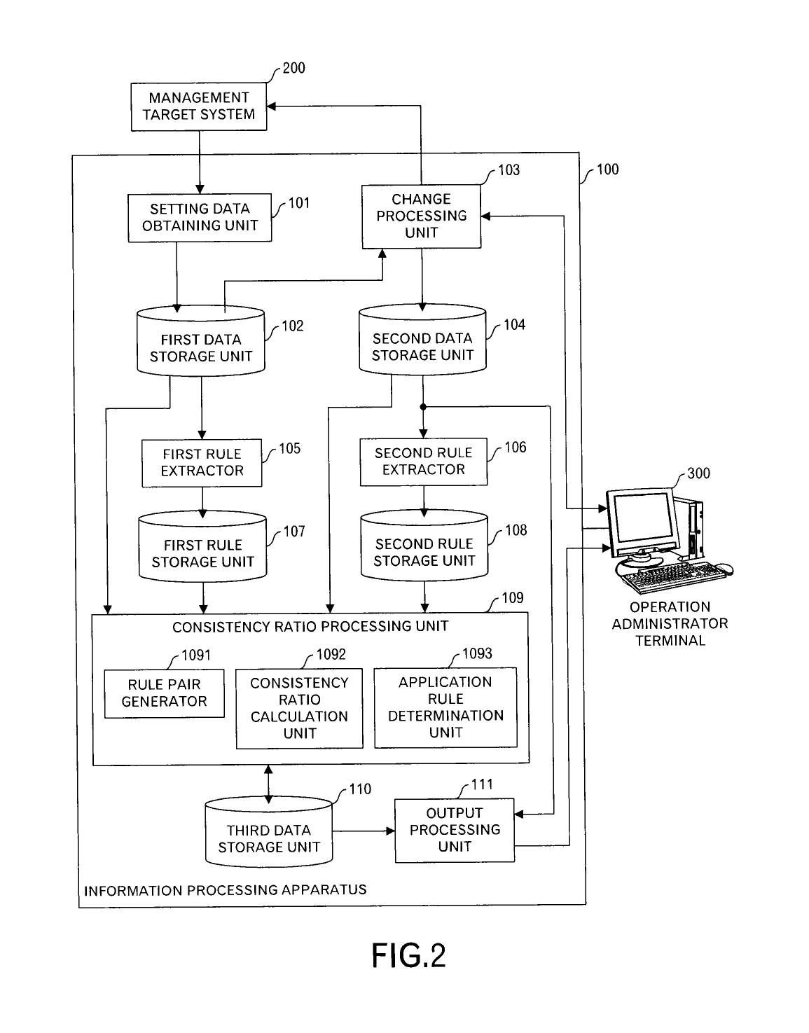

FIG. 2 illustrates a system relating to an embodiment of this technique. The system relating to this embodiment includes an operation administrator terminal 300, an information processing apparatus 100 and a management target system 200 managed by an operation administrator. The information processing apparatus 100 has a setting data obtaining unit 101, a first data storage unit 102, a change processing unit 103, a second data storage unit 104, a first rule extractor 105, a second rule extractor 106, a first rule storage unit 107, a second rule storage unit 108, a consistency ratio processing unit 109, and a third data storage unit 110 and an output processing unit 111.

The setting data obtaining unit 101 obtains present setting data (also called setting data before change) from the management target system 200, and stores the obtained setting data into the first data storage unit 102. The present setting data may be obtained from a computer such as the operation administrator terminal 300. The change processing unit 103 generates setting data after change according to an instruction from the operation administrator terminal 300, and stores the generated setting data into the second data storage unit 104. The first rule extractor 105 extracts a first rule from the present setting data that is stored in the first data storage unit 102, and stores the extracted first rule into the first rule storage unit 107. Moreover, the second rule extractor 106 extracts a second rule from the setting data after change, which is stored in the second data storage unit 104, and stores the extracted second rule into the second rule storage unit 108.

The consistency ratio processing unit 109 performs a processing by using data stored in the first data storage unit 102, second data storage unit 104, first rule storage unit 107 and second rule storage unit 108, and stores data during the processing and processing results into the third data storage unit 110. Moreover, the consistency ratio processing unit 109 has a rule pair generator 1091, a consistency ratio calculation unit 1092 and an application rule determination unit 1093. The rule pair generator 1091 associates the first rule with the second rule to perform a processing. The consistency ratio calculation unit 1092 calculates a consistency ratio (which may be called “matching ratio”) when the first rule is applied to the setting data after change, and a consistency ratio when the second rule is applied to the present setting data. The application rule determination unit 1093 identifies a rule to be anteceded, from the magnitude correlation of the consistency ratios.

The output processing unit 111 uses data stored in the third data storage unit 110 to generate data to be outputted to the operation administrator terminal 300, and outputs the generated data to the operation administrator terminal 300. The final setting data is outputted and set to the management target system 200 from the change processing unit 103, for example.

Next, processing contents of the system illustrated in FIG. 2 will be explained by using FIGS. 3 to 12. For example, in response to an instruction from the operation administrator terminal 300, the setting data obtaining unit 101 obtains the present setting data from the management target system 200, for example, and stores the obtained present setting data into the first data storage unit 102. Moreover, the change processing unit 103 outputs the present setting data, which is stored in the first data storage unit 102, to the operation administrator terminal 300, for example, and the operation administrator terminal 300 outputs the present setting data to have the operation administrator change the present setting data.

For example, the present setting data is assumed to be data as illustrated in FIG. 3. In an example of FIG. 3, for each of 4 servers, a parameter value is set for each of setting parameters including a region “Region”, IP address of a name server “nameserver”, a language “LANG”, a presence of utilization of Coordinated Universal Time (UTC) “UTC” and a setting method of IP address “BOOTPROTO”.

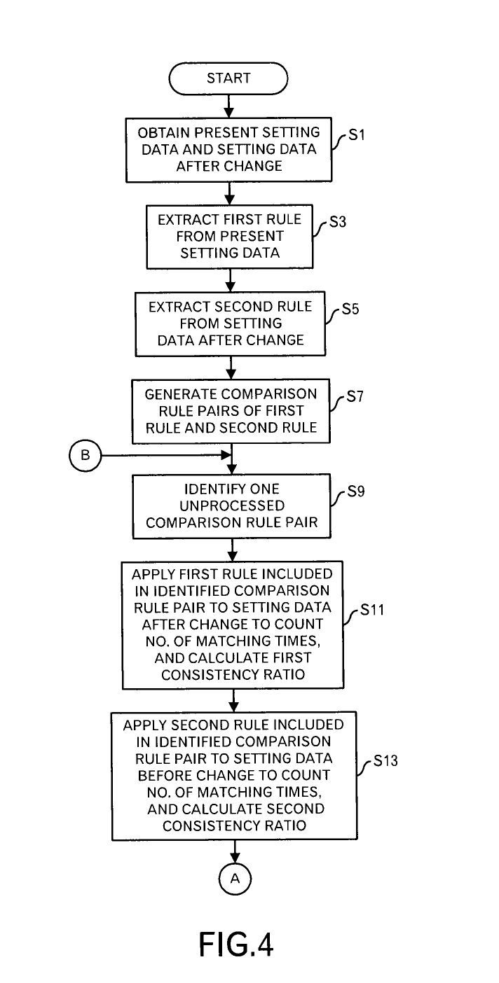

The operation administrator operates the operation administrator terminal 300 to make a change for the setting data, and the operation administrator terminal 300 outputs the setting data after change to the change processing unit 103. The change processing unit 103 obtains the setting data after change from the operation administrator terminal 300, and stores the obtained setting data after change into the second data storage unit 104 (FIG. 4: step S1).

For example, the operation administrator made changes for the server 1 in order to change the setting parameter “LANG” for all servers to “en”, however, at the same time, the operation administrator wrongly changed the value of the name server to “192.168.3.1”. Furthermore, it is assumed that the operation administrator copied and pasted the parameter values of the setting parameters other than “Region” for the server 1 to the server 2. In such a case, the setting data as illustrated in FIG. 5 is stored in the second data storage unit 104. In FIG. 5, data surrounded by thick lines is data that was wrongly changed.

Next, the first rule extractor 105 extracts the first rules from the present setting data, which is stored in the first data storage unit 102, and stores data of the extracted first rules into the first rule storage unit 107 (step S3).

Moreover, the second rule extractor 106 extracts the second rules from the setting data after change, which is stored in the second data storage unit 104, and stores data of the extracted second rules into the second rule storage unit 108 (step S5).

In this embodiment, one or plural rules are generated for each setting parameter. A method for generating a rule is similar to a conventional art, and the method itself is not a main portion of this embodiment. Therefore, the detailed explanation is omitted. For example, a decision tree like C4.5, which is described in Filho, J. C. R., Affonso, C. M., Oliveira, R. C. L., “Pricinganalysis in the Brazilian energy market: A decision tree approach”, PowerTech, 2009 IEEE Bucharest, or the like may be used. Moreover, the steps S3 and S5 may be executed in parallel, or may be executed in reversed order.

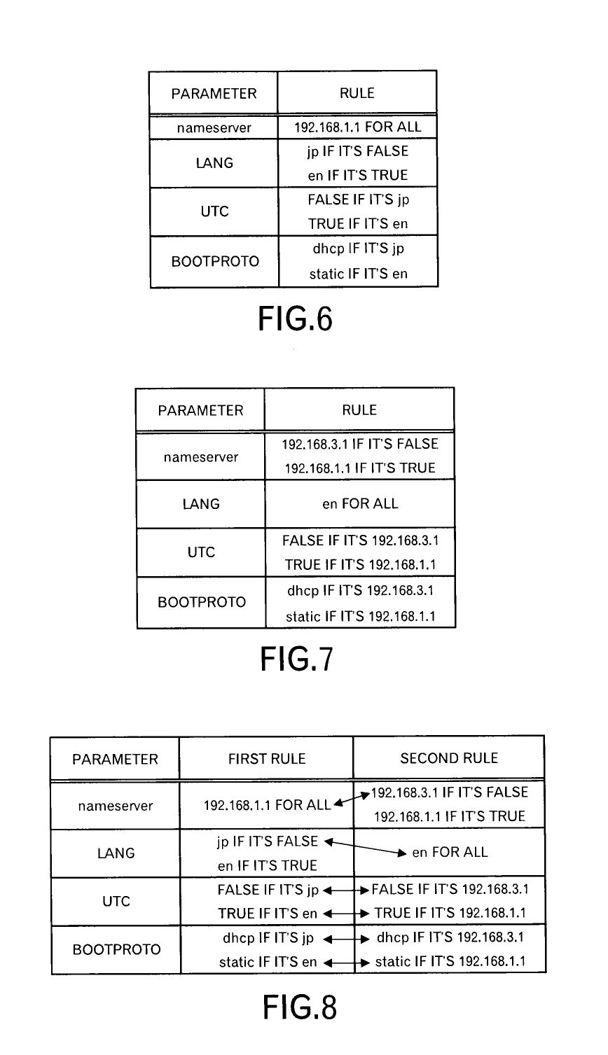

For example, the first rule, which was generated from the present setting data illustrated in FIG. 3, will be explained by using FIG. 6. In an example of FIG. 6, a rule “192.168.1.1 for all” is generated for the name server. Moreover, as for LANG, rules “jp if UTC represents FALSE” and “en if UTC represents TRUE” are generated. As for UTC, rules “FALSE if LANG represents jp” and “TRUE if LANG represents en” are generated. As for BOOTPROTO, rules “dhcp if LANG represents jp” and “static if LANG represents en” are generated. Typically, the rules include a condition part and a conclusion part. A condition concerning a parameter value for a setting parameter that is different from a target setting parameter is set to the condition part or a condition “all” is set. Moreover, the parameter value to be set to the target setting parameter is included in the conclusion part.

On the other hand, the second rule, which was generated from the setting data after change, which was illustrated in FIG. 5, will be explained by using FIG. 7. In an example of FIG. 7, as for the name server, rules “192.168.3.1 if UTC represents FALSE” and “192.168.1.1 if UTC represents TRUE” are generated. Moreover, as for LANG, a rule “en for all” is generated. As for UTC, rules “FALSE if the name server represents 192.168.3.1” and “TRUE if the name server represents 192.168.1.1” are generated. As for BOOTPROTO, rules “dhcp if the name server represents 192.168.3.1” and “static if the name server represents 192.168.1.1” are generated.

Then, the rule pair generator 1091 of the consistency ratio processing unit 109 generates a comparison rule pair of the first rule stored in the first rule storage unit 107 and the second rule stored in the second rule storage unit 108, and stores data of the comparison rule pair into the third data storage unit 110 (step S7). Here, as one example, for each setting parameter, a pair including one first rule and one second rule is generated. However, when the first rule is the same as the second rule, the pair is excluded. This is because it is impossible to identify a setting mistake in the following processing. Moreover, a rule that one of the first rule and second rule contains the other is also excluded. For example, where there are a rule “dhcp if LANG represents jp” and a rule “dhcp for all”, “dhcp for all” contains a condition part of “LANG represents jp”, because the condition part of “dhcp for all” represents any condition part. Therefore, such a pair of these rules is excluded. Also in such a case, this is because it is impossible to compare the first rule with the second rule in the following processing, appropriately.

Moreover, when the comparison rule pair is generated, rules having the same conclusion part are paired, fundamentally. When the aforementioned excluded pair is obtained, rules having the different conclusion part are also paired.

In case of the first rule illustrated in FIG. 6 and the second rule illustrated in FIG. 7, the comparison rule pair as illustrated in FIG. 8 is generated. In case of the name server, as a principle, “192.168.1.1 for all” and “192.168.1.1 if UTC represents TRUE” should be paired, however, this pair is excluded because the former contains the latter. Therefore, “192.168.1.1 for all” and “192.168.3.1 if UTC represents FALSE” are set as a comparison rule pair. As for LANG, as a principle, “en if UTC represents TRUE” and “en for all” should be paired, however, this pair is excluded, because the latter contains the former. Therefore, “jp if UTC represents FALSE” and “en for all” are set as a comparison rule pair. Furthermore, as for UTC, “FALSE if LANG represents jp” and “FALSE if the name server represents 192.168.3.1” are set as a comparison rule pair, and “TRUE if LANG represents en” and “TRUE if the name server represents 192.168.1.1” are set as a comparison rule pair. Furthermore, as for BOOTPROTO, “dhcp if LANG represents jp” and “dhcp if the name server represents 192.168.3.1” are set as a comparison rule pair, and “static if LANG represents en” and “static if the name server represents 192.168.1.1” are set as a comparison rule pair.

After that, the consistency ratio calculation unit 1092 of the consistency ratio processing unit 109 identifies one unprocessed comparison rule pair among the comparison rule pairs that were generated at the step S7 (step S9). Then, the consistency ratio calculation unit 1092 applies the first rule included in the identified comparison rule pair to the setting data after change, which is stored in the second data storage unit 104, counts the number of times that the setting data after change conforms to the first rule, calculates a first consistency ratio by dividing the counted number of times by the number of times that the condition part of the first rule is satisfied, and stores the calculated first consistency ratio into the third data storage unit 110 (step S11).

In an example of FIG. 8, when the first rule “192.168.1.1 for all” is applied to the setting data after change, 4 servers satisfy the condition part of the first rule, and 2 servers of the 4 servers conform to the value of the conclusion part of the first rule. Therefore, the consistency ratio “0.5” is obtained. Moreover, when the first rule “jp if UTC represents FALSE” is applied to the setting data after change, 2 servers satisfy the condition part of the first rule, and because no server conform to the value of the conclusion part of the first rule. Therefore, the consistency ratio “0” is obtained. When the first rule “FALSE if LANG represents jp” is applied to the setting data after change, no server satisfies condition part of the first rule. Therefore, the consistency ratio “0” is obtained. Furthermore, when the first rule “TRUE if LANG represents en” is applied to the setting data after change, 4 servers satisfy the condition part of the first rule, and 2 servers of the 4 servers conform to the value of the conclusion part of the first rule. Therefore, the consistency ratio “0.5” is obtained. Furthermore, when the first rule “dhcp if LANG represents jp” is applied to the setting data after change, no server satisfies the condition part of the first rule. Therefore, the consistency ratio “0” is obtained. Moreover, when the first rule “static if LANG represents en” is applied to the setting data after change, 4 servers satisfy the condition part of the first rule, and 2 servers of the 4 servers conform to the conclusion part of the first rule, the consistency ratio “0.5” is obtained.

Furthermore, the consistency ratio calculation unit 1092 applies the second rule included in the identified comparison rule pair to the present setting data (i.e. setting data before change) stored in the first data storage unit 102, counts the number of times that the present setting data conforms to the second rule, calculates the second consistency ratio by dividing the counted number of times by the number of times that the condition part of the second rule is satisfied, and stores the calculated second consistency ratio into the third data storage unit 110 (step S13). Then, the processing shifts to a processing in FIG. 10 through terminal A.

In an example of FIG. 8, when the second rule “192.168.3.1 if UTC represents FALSE” is applied to the present setting data, one server satisfies the condition part of the second rule, and the server does not conform to the value of the conclusion part of the second rule. Therefore, the consistency ratio “0” is obtained. Moreover, when the second rule “en for all” is applied to the present setting data, 4 servers satisfy the condition part of the second rule, and three servers of the 4 servers conform to the value of the conclusion part of the second rule. Therefore, the consistency ratio “0.75” is obtained. Furthermore, when the second rule “FALSE if the name server represents 192.168.3.1” is applied to the present setting data, no server satisfies the condition part of the second rule. Therefore, the consistency ratio “0” is obtained. Moreover, when the second rule “TRUE if the name server represents 192.168.1.1” is applied to the present setting data, 4 servers satisfy the condition part of the second rule, and three servers of the 4 servers conform to the value of the conclusion part of the second rule. Therefore, the consistency ratio “0.75” is obtained. Furthermore, the second rule “dhcp if the name server represents 192.168.3.1” is applied to the present setting data, no server satisfies the condition part of the second rule. Therefore, the consistency ratio “0” is obtained. Moreover, the second rule “static if the name server represents 192.168.1.1” is applied to the present setting data, 4 servers satisfy the condition part of the second rule, and three servers of the 4 servers conform to the value of the conclusion part of the second rule. Therefore, the consistency ratio “0.75” is obtained.

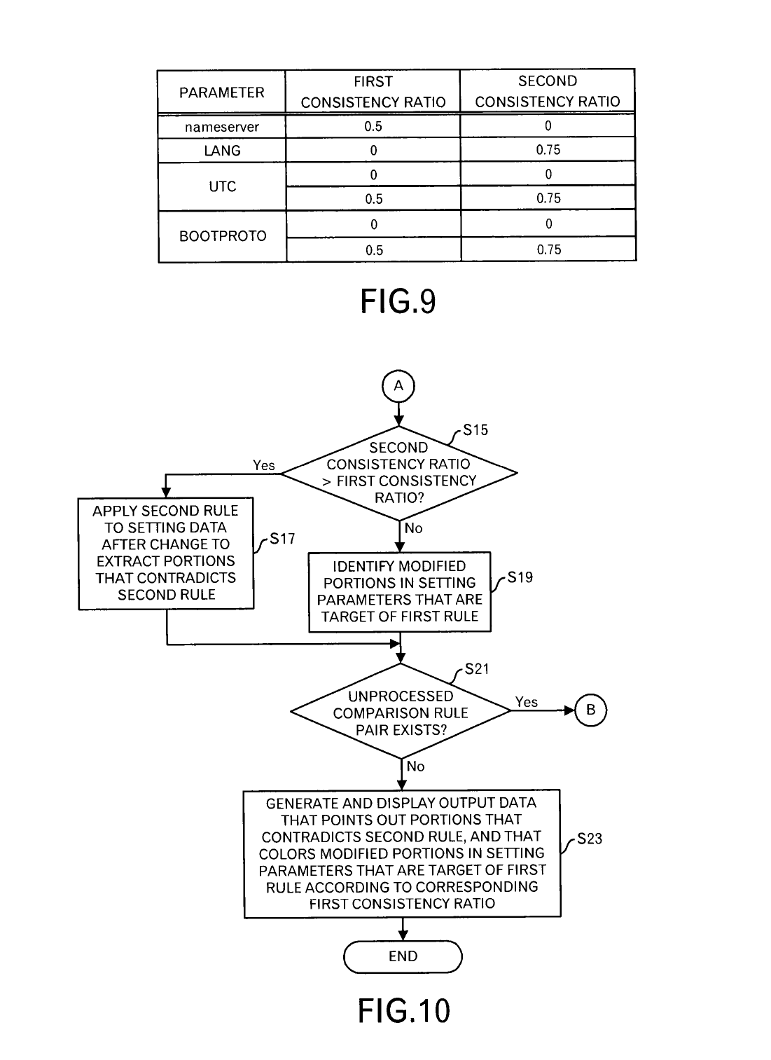

When the aforementioned processing results are summarized, the result as illustrated in FIG. 9 is obtained. In an example of FIG. 9, as for each setting parameter, the consistency ratio for the first rule and the consistency ratio for the second rule are stored. However, such data is not obtained once, however, data is obtained for each line by this processing flow.

Shifting to the explanation of the processing in FIG. 10, the application rule determination unit 1093 determines whether or not the second consistency ratio is greater than the first consistency ratio (step S15). When the second consistency ratio is greater than the first consistency ratio, the application rule determination unit 1093 applies the second rule to the setting data after change, which is stored in the second data storage unit 104, to extract portions that contradict the second rule, and stores the extracted portions into the third data storage unit 110 (step S17). Then, the processing shifts to step S21.

Thus, when the condition like the step S17 is satisfied, it is possible to determine, based on the intention that the rule up to now is changed, that the change was made. Therefore, the second rule is applied.

According to the example in FIG. 9, when the second rule “en for all” for the setting parameter LANG is applied to the setting data after change, all of the 4 servers conform to the second rule. Therefore, in this example, there is no portion that contradicts the second rule. Moreover, when the second rule “TRUE if the name server represents 192.168.1.1” for the setting parameter UTC is applied to the setting data after change, two servers satisfy the condition part of the second rule, these two servers also conform to the value of the conclusion part of the second rule. Therefore, there is no portion that contradicts the second rule in this example. Furthermore, when the second rule “static if the name server represents 192.168.1.1” for the setting parameter BOOTPROTO is applied to the setting data after change, two servers satisfy the condition part of the second rule. Therefore, because those servers conform to the value of the conclusion part of the second rule, there is no portion that contradicts the second rule.

If there is a portion that contradicts the second rule, data concerning a combination of the setting parameter name and server name in the pertinent portion is stored in the third data storage unit 110. Thus, assuming that the rule is changed by the correct setting change, the second rule is anteceded at the step S17.

On the other hand, when the second consistency ratio is less than the first consistency ratio, it is possible to determine that the rule is changed by the wrong setting change. Then, the first rule is applied. When the second consistency ratio is equal to the first consistency ratio, it is impossible to determine whether any of them is correct. Because of the safety, it is assumed that the wrong setting change was made. Therefore, the first rule is applied. In other words, when the second consistency ratio is equal to the first consistency ratio or when the second consistency ratio is less than the first consistency ratio, the application rule determination unit 1093 identifies a modified portion in the setting parameter that is a target of the first rule by comparing the setting data stored in the first data storage unit 102 with the setting data stored in the second data storage unit 104, and stores data to identify the modified portion into the third data storage unit 110 (step S19). Then, the processing shifts to the step S21.

In an example of FIG. 9, in case where the setting parameter is the name server, the first consistency ratio of the first rule is greater. Therefore, a modified portion for this setting parameter is identified. Then, the IP addresses of the name servers for the servers 1 and 2 are identified as the modified portions. Similarly, as for one comparison rule pair for the setting parameter UTC, the consistency ratio of the first and second rules is the same. Therefore, the modified portion for this setting parameter is identified. Then, UTC of the server 2 is identified as the modified portion. Furthermore, as for one comparison rule pair for the setting parameter BOOTPROTO, the consistency ratio of the first and second rules is the same. Therefore, the modified portion for this setting parameter is identified. Then, BOOTPROTO of the server 2 is identified as the modified portion.

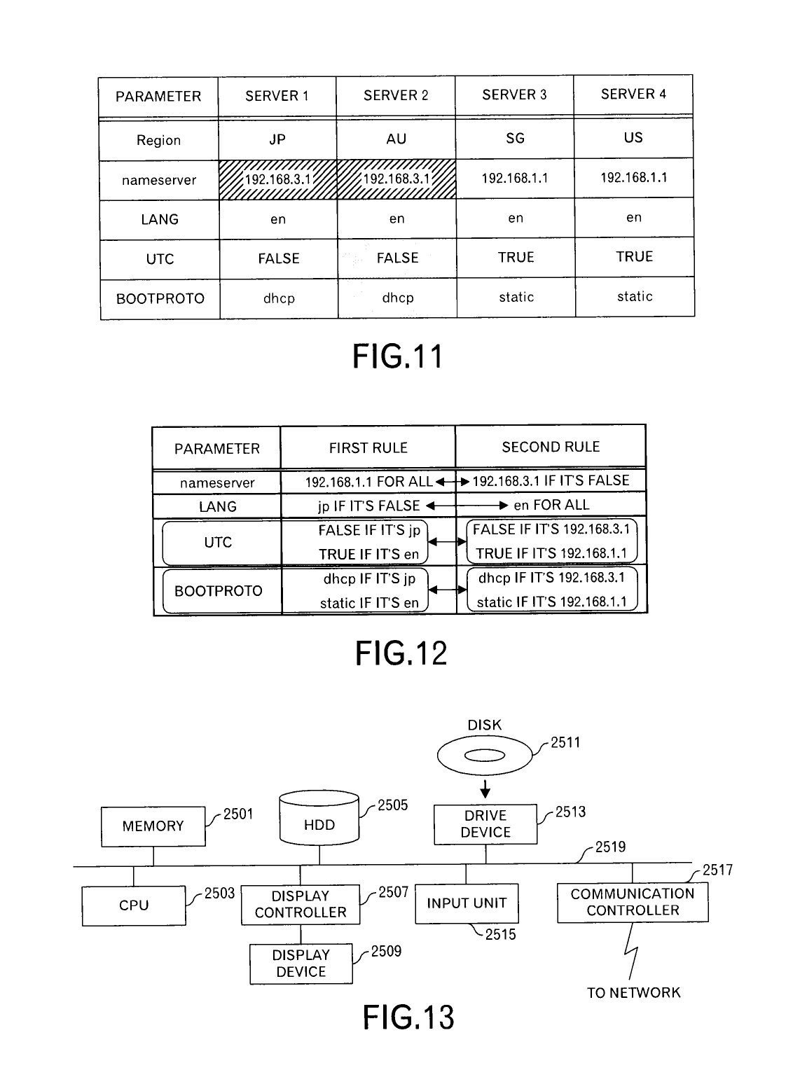

After that, the consistency ratio calculation unit 1092 determines whether or not there is an unprocessed comparison rule pair among the comparison rule pairs illustrated in FIG. 8 (step S21). When there is an unprocessed comparison rule pair, the processing returns to the step S9 in FIG. 4 through the terminal B. On the other hand, when there is no unprocessed comparison rule pair, the output processing unit 111 points out a portion that was identified at the step S17 and contradicts the second rule, generates output data that the modified portion in the setting parameter, which was identified at the step S19 and is the target of the first rule, is colored according to the corresponding first consistency ratio, and outputs the output data to the operation administrator terminal 300, for example (step S23). At this time, the setting data after change, which is stored in the second data storage unit 104, is used. In other words, data as illustrated in FIG. 11 is generated. An example of FIG. 11 is generated based on the result illustrated in FIG. 9, and the IP addresses of the name servers for the servers 1 and 2, UTC of the server 2 and BOOTPROTO of the server 2 are identified at the step S19. Therefore, these are presented in a recognizable form. However, as for the IP addresses of the name servers for the servers 1 and 2, the first consistency ratio “0.5” and the second consistency ratio “0” are obtained, and the difference between the first consistency ratio and the second consistency ratio is great. Therefore, much emphasized coloring is made. For example, a dark color is assigned. On the other hand, as for UTC and BOOTPROTO of the server 2, the first consistency ratio is equal to the second consistency ratio. Therefore, a lighter color than that of the name server is assigned. Thus, in this example, when the difference with the second consistency ratio is greater, a darker color is assigned. However, the coloring may be carried out according to a ratio to the second consistency ratio. Other methods for the coloring may be employed.

In this example, LANG of the server 1 is intentionally modified, however, is not identified at the steps S17 and S19. In other words, the wrong change is appropriately identified, and it is possible to warn the operation administrator of it.

When the operation administrator terminal 300 receives the output data from the output processing unit 111 of the information processing apparatus 100, the operation administrator terminal 300 outputs it to the display apparatus. When data as illustrated in FIG. 11 is displayed, it is possible for the operation administrator to determine whether or not there is possibility that either value of either setting parameter is a setting error. The operation administrator performs correction based on such output data again, and causes the operation administrator terminal 300 to transmit the corrected data to the change processing unit 103 of the information processing apparatus 100. When the change processing unit 103 receives the corrected data, the change processing unit 103 performs a processing for setting the corrected data to the management target system 200. Thus, the correct setting parameter is set.

Thus, a case where the setting rule was changed because of the setting mistake can be identified, and the setting mistake can be detected. Furthermore, in such a case, it is possible to present the setting mistake in descending order of the possibility of the setting mistake to the operation administrator. Therefore, it is possible to perform a test before the actual setting change, and it is also possible to prevent troubles of the management target system beforehand. Furthermore, when this processing is performed for each setting change, it is possible to follow not only the setting mistake but also the rule change, and it is possible to continuously perform appropriate setting changes.

The output data in FIG. 11 is an example, and problems may be pointed out by other modes. For example, only problems may be listed and presented, and the setting data after change may be presented in another window or the like. Furthermore, what rule was anteceded may be presented. The first rule and second rule may be presented.

Furthermore, as for the method for generating the comparison rule pair, there are variations. In the aforementioned example, a pair is generated for each setting parameter and further per a rule. However, as schematically illustrated in FIG. 12, a pair for some rules may be generated for each setting parameter. In an example of FIG. 12, a first rule for the setting parameter UTC includes two rules, and the second rule includes two rules, however, those are paired. Similarly, for the setting parameter BOOTPROTO, the first rule includes two rules and the second rule includes two rules, however, those are paired.

As a further variation, a pair may be generated for plural setting parameters. In the example of FIG. 12, for example, the name server and LANG are collected, and the first and second rules, which include rules for those setting parameters, are paired.

Although the embodiments of this technique were explained, this technique is not limited to these. For example, as for the processing flow, as long as the processing results do not change, the processing turns may be exchanged, or plural steps may be executed in parallel. Furthermore, the functional block diagram in FIG. 2 is an example, and does not always correspond to an actual program module configuration. Furthermore, similarly, the data holding mode is an example, and another data holding mode may be employed.

Moreover, in the aforementioned example, when the first consistency ratio is equal to the second consistency ratio, the step S19 is performed, however, the step S17 may be performed. Furthermore, instead of the steps S17 and S19, display representing no rule of the first and second rules is applicable may be made. Furthermore, when there is no rule that conforms to the condition part for any of the first and second rules, the processing result may be presented further in another way.

Furthermore, the operation administrator terminal 300 may have all or parts of functions in the information processing apparatus 100.

In addition, the aforementioned information processing apparatus 100 is a computer device as illustrated in FIG. 13. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 13. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An information processing method relating to the embodiments includes

(A) first generating a first rule for each of plural parameters from first data including a parameter value of each of the plural parameters for each of plural setting targets; (B) second generating a second rule for each of the plural parameters from second data that is data after at least one parameter value included in the first data was changed; (C) third generating, for each group including one or plural parameters among the plural parameters, a pair of the first rule and the second rule, which include a parameter of the group; (D) calculating, for each pair of plural generated pairs, a first consistency ratio by applying the first rule included in the pair to the second data and a second consistency ratio by applying the second rule included in the pair to the first data; (E) with respect to a first pair whose second consistency ratio exceeds the first consistency ratio, first presenting a parameter value of a parameter, which contradicts the second rule included in the pair, in the second data to a user; and (F) with respect to a second pair whose first consistency ratio exceeds the second consistency ratio, second presenting a changed parameter value among parameter values of parameters relating to the pair to the user.

By doing so, even when the change was erroneously made, it becomes possible to perform warning for the user, appropriately. The first rule relating to the pair may include plural rules, and the second rule relating to the pair may include plural rules.

Furthermore, in the aforementioned first or second presenting, the changed parameter value may be displayed so as to be distinguished according to a difference or a ratio between the first consistency ratio and the second consistency ratio. With this configuration, it becomes possible to distinguish and confirm the parameter value whose possibility of the error is high.

Moreover, the method may further include: upon detecting that the first consistency ratio is equal to the second consistency ratio, presenting the changed parameter value to the user. This presumes that the parameter value before change is used as the standard, however, other methods may be employed.

Furthermore, the third generating may include excluding, in the group, a pair whose first rule is identical with the second rule and a pair that one of the first rule and the second rule includes the other. In order to perform appropriate comparison, this is performed.

Furthermore, the aforementioned first consistency ratio may be calculated by counting the first number of setting targets including a parameter value that satisfies a condition of the first rule, counting the second number of times that a parameter value of a parameter that is included in the setting targets counted for the first number and is a target of the first rule is identical to a parameter value in a conclusion part included in the first rule, and dividing the second number of times by the first number of setting targets. The aforementioned second consistency ratio may be calculated by counting the third number of setting targets including a parameter value that satisfies a condition of the second rule, counting the fourth number of times that a parameter value of a parameter that is included in the setting targets counted for the third number and is a target of the second rule is identical to a parameter value in a conclusion part included in the second rule, and dividing the fourth number of times by the third number of setting targets.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process comprising:
first generating a first rule for each of a plurality of parameters from first data including a parameter value of each of the plurality of parameters for each of a plurality of setting targets;
second generating a second rule for each of the plurality of parameters from second data that is data after at least one parameter value included in the first data was changed;
third generating, for each group including one or plural parameters among the plurality of parameters, a pair of the first rule and the second rule, which include a parameter of the group;
calculating, for each pair of a plurality of generated pairs, a first consistency ratio by applying the first rule included in the pair to the second data and a second consistency ratio by applying the second rule included in the pair to the first data;
with respect to a first pair whose second consistency ratio exceeds the first consistency ratio, first presenting a parameter value of a parameter, which contradicts the second rule included in the pair, in the second data to a user; and
with respect to a second pair whose first consistency ratio exceeds the second consistency ratio, second presenting a changed parameter value among parameter values of parameters relating to the pair to the user.

2. The computer-readable, non-transitory storage medium as set forth in claim 1, wherein, in the first presenting or the second presenting, the changed parameter value is displayed so as to be distinguished according to a difference or a ratio between the first consistency ratio and the second consistency ratio.

3. The computer-readable, non-transitory storage medium as set forth in claim 1, wherein the process further comprises:
upon detecting that the first consistency ratio is equal to the second consistency ratio, presenting the changed parameter value to the user.

4. The computer-readable, non-transitory storage medium as set forth in claim 1, wherein the third generating comprises excluding, in the group, a pair whose first rule is identical with the second rule and a pair that one of the first rule and the second rule includes the other.

5. The computer-readable, non-transitory storage medium as set forth in claim 1, wherein the first consistency ratio is calculated by counting a first number of setting targets including a parameter value that satisfies a condition of the first rule, counting a second number of times that a parameter value of a parameter that is included in the setting targets counted for the first number and is a target of the first rule is identical to a parameter value in a conclusion part included in the first rule, and dividing the second number of times by the first number of setting targets, and
the second consistency ratio is calculated by counting a third number of setting targets including a parameter value that satisfies a condition of the second rule, counting a fourth number of times that a parameter value of a parameter that is included in the setting targets counted for the third number and is a target of the second rule is identical to a parameter value in a conclusion part included in the second rule, and dividing the fourth number of times by the third number of setting targets.

6. An information processing method, comprising:
first generating, by using a computer, a first rule for each of a plurality of parameters from first data including a parameter value of each of the plurality of parameters for each of a plurality of setting targets;
second generating, by using the computer, a second rule for each of the plurality of parameters from second data that is data after at least one parameter value included in the first data was changed;
third generating, by using the computer and for each group including one or plural parameters among the plurality of parameters, a pair of the first rule and the second rule, which include a parameter of the group;
calculating, by using the computer for each pair of a plurality of generated pairs, a first consistency ratio by applying the first rule included in the pair to the second data and a second consistency ratio by applying the second rule included in the pair to the first data;
with respect to a first pair whose second consistency ratio exceeds the first consistency ratio, first presenting, by using the computer, a parameter value of a parameter, which contradicts the second rule included in the pair, in the second data to a user; and
with respect to a second pair whose first consistency ratio exceeds the second consistency ratio, second presenting, by using the computer, a changed parameter value among parameter values of parameters relating to the pair to the user.

7. An information processing apparatus, comprising:
a memory; and
a processor configured to use the memory and execute a process comprising:
first generating a first rule for each of a plurality of parameters from first data including a parameter value of each of the plurality of parameters for each of a plurality of setting targets ;
second generating a second rule for each of the plurality of parameters from second data that is data after at least one parameter value included in the first data was changed;
third generating, for each group including one or plural parameters among the plurality of parameters, a pair of the first rule and the second rule, which include a parameter of the group;
calculating, for each pair of a plurality of generated pairs, a first consistency ratio by applying the first rule included in the pair to the second data and a second consistency ratio by applying the second rule included in the pair to the first data;
with respect to a first pair whose second consistency ratio exceeds the first consistency ratio, first presenting a parameter value of a parameter, which contradicts the second rule included in the pair, in the second data to a user; and
with respect to a second pair whose first consistency ratio exceeds the second consistency ratio, second presenting a changed parameter value among parameter values of parameters relating to the pair to the user.
